(19) United States
(12) Patent Application Publication
(10) Pub. No.: US 2005/0046204 A1
(43) Pub. Date: Mar. 3, 2005

(54) Latching axle assembly for a knob of a door lock

(75) Inventor: Chun-Cheng Lin, Kangshan Chen (TW)

Correspondence Address: VENABLE, BAETJER, HOWARD AND CIVILETTI, LLP, P.O. BOX 34385, WASHINGTON, DC, 20043-9998, US

(73) Assignee: Taiwan Fu Hsing Industrial Co., Ltd., Kangshan Chen (TW)

(21) Appl. No.: 10/653,267

(22) Filed: Sep. 3, 2003

(51) Int. Cl. E05B 3/00

(52) U.S. Cl. 292/358

(57) ABSTRACT

A latching axle assembly includes an axle having a head formed at an end of the axle. Multiple recesses are defined at an outer periphery of the head. A cap has multiple protrusions formed at an inner wall of the cap and respectively positioned in the recesses to detachably mount the cap on the head. The cap can be easily and quickly mounted on the axle, and can be detached from an axle found to be defective.

### BACKGROUND OF THE INVENTION

1. Field of the Invention

The present invention relates to a knob of a door lock, and more particularly to a latching axle for the knob.

2. Description of Related Art

A door lock generally has two knobs respectively installed at an interior and an exterior side of the door. The interior knob has a latching axle assembly for latching the door lock to disable the exterior knob to turn so as to provide security for the person(s) in the room.

With reference to FIGS. 6-7, a conventional latching axle assembly has an axle (30) and a head (31) formed at an end of the axle (30), and a cap (32) mounted outside the head (31). The cap (32) is made of metal material and is commonly electroplated. A flange (33) is formed at a bottom of the cap (32) by punching to secure the cap (32) on the head (31).

However, in the manufacture of the axle (30) and the cap (32), it is a time-consuming process to position the axle (30) and the cap (32) on a punching machine so as to punch the cap (32) to secure it on the axle (30). Furthermore, the finished cap (32) is integrated with the axle (30) and can not be detached without destroying the axle (30). Thus, if an axle (30) with some imperfection needs to be discarded, the cap (32) must also be abandoned because it is too difficult to remove from the axle (30). Accordingly, the wastage involved renders the manufacturing cost high.

Therefore, the invention provides a latching axle assembly to mitigate and/or obviate the aforementioned problems.

### SUMMARY OF THE INVENTION

The main objective of the invention is to provide a latching axle assembly which can save the manufacturing time and cost.

Other objectives, advantages and novel features of the invention will become more apparent from the following detailed description when taken in conjunction with the accompanying drawings.

### BRIEF DESCRIPTION OF THE DRAWINGS

FIG. 1 is a part cross sectional view of a latching axle in accordance with the invention;

FIG. 2 is a top view of the latching axle in FIG. 1;

FIG. 3 is a cross sectional view of the latching axle installed in a knob;

FIG. 4 is a part cross sectional view of another embodiment of the latching axle;

FIG. 5 is a top view of the latching axle in FIG. 4

FIG. 6 is a part cross sectional view of a conventional latching axle; and

FIG. 7 is a top view of the conventional latching axle.

### DETAILED DESCRIPTION OF THE PREFERRED EMBODIMENT

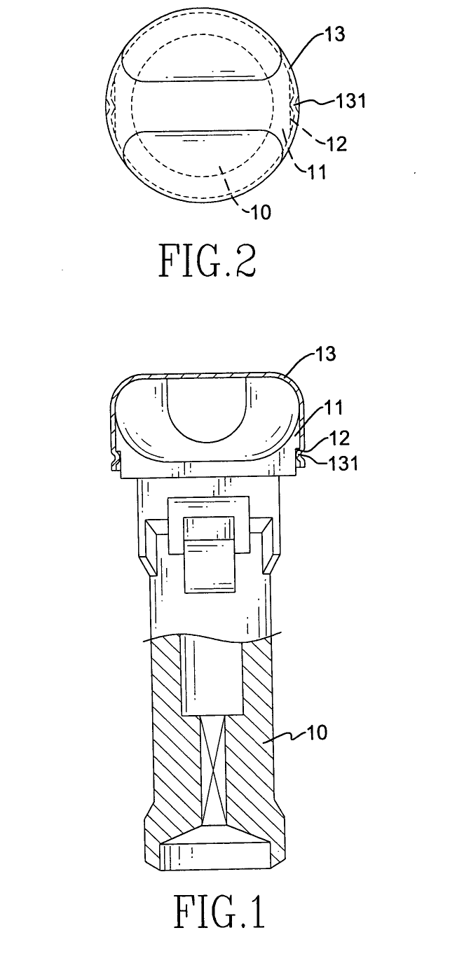

With reference to FIGS. 1-2, a latching axle assembly in accordance with the present invention has an axle (10) and a head (11) formed at an end of the axle (10). Multiple recesses (12) are defined at an outer periphery of the head (11). A cap (13) is made of metal material and is electroplated. Multiple protrusions (131) are formed at an inner wall of the cap (13) and can be respectively positioned in the recesses (12) to securely mount the cap (13) on the head (11).

In this embodiment, the axle (10) has two recesses (12) defined at diametrical opposite sides of the head (11), and the cap (13) has two protrusions (131) respectively positioned in the recesses (12).

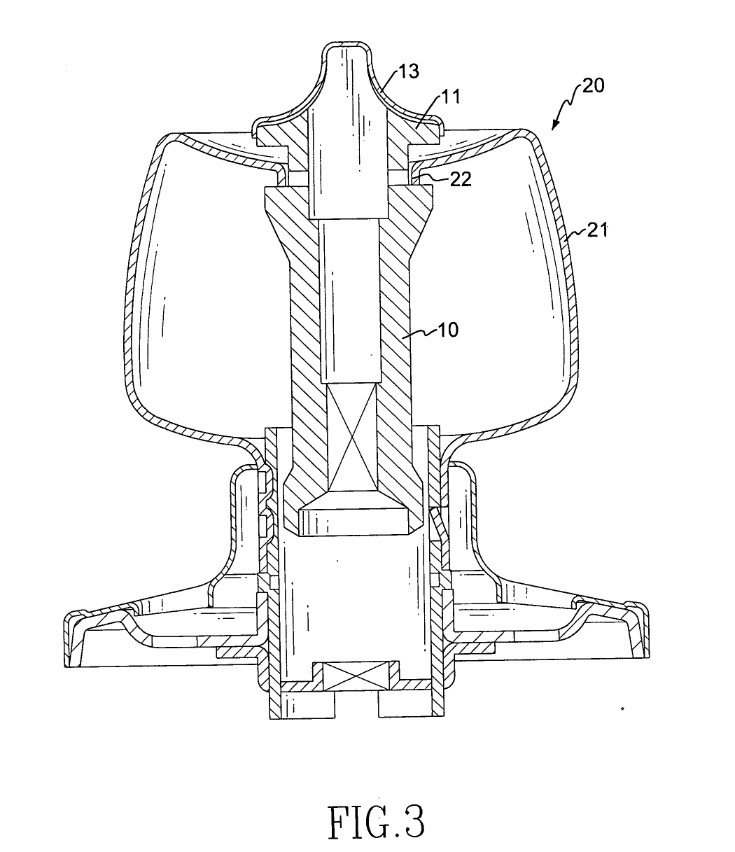

With reference to FIG. 3, a knob (21) of a door lock (20) has an opening (22), and the axle (10) is mounted in the opening (22). When a user turns the axle (10) by rotating the cap (13), the door lock (20) can be latched.

In the manufacturing process, if the axle (10) has some blemishes and must be discarded, the cap (12) can be detached from the axle (10) and reinstalled on another axle (10), thereby avoiding the additional cost of unnecessarily scrapping the acceptable cap (12).

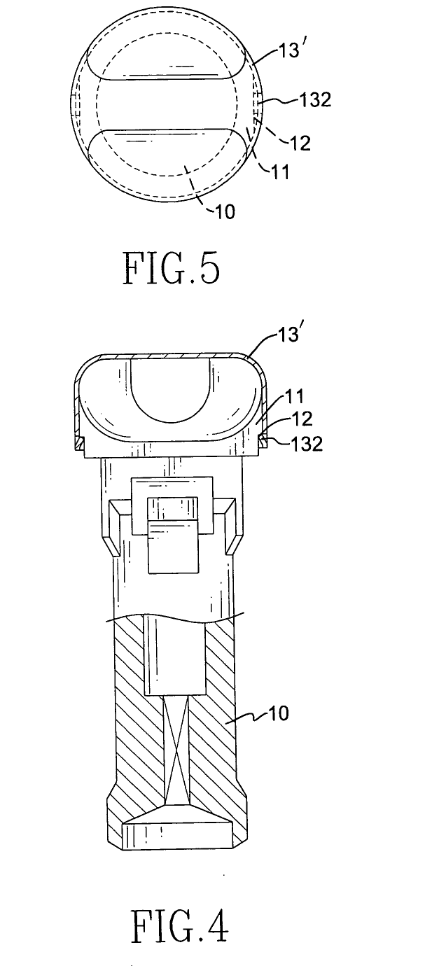

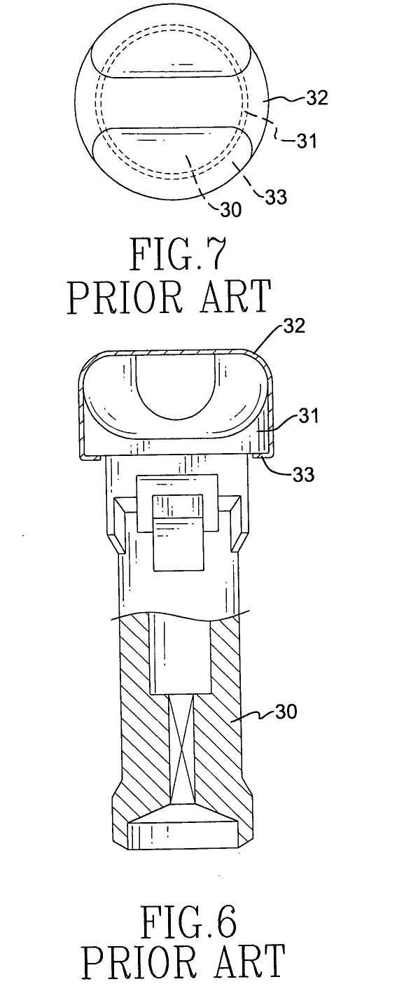

With reference to FIGS. 4-5, in another embodiment of the invention, the axle (10) has the same structure as described above, the cap (13′) has multiple hooks (132) formed at a lower circumference thereof and attached in the respective recesses (12) of the axle (10). The cap (13′) is then securely mounted on the head (12).

According to the present invention, the cap (13) can be easily and quickly mounted on the axle (10) in about 2-3 seconds. Moreover, the cap (13) can be detached from a defective axle (10) to avoid high costs arising from scrap products.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A latching axle assembly comprising:
an axle having a head formed at an end of the axle, and multiple recesses defined at an outer periphery of the head; and
a cap having multiple protrusions formed at an inner wall of the cap and the multiple protrusions respectively positioned in the recesses to detachably mount the cap on the head.

2. The latching axle assembly as claimed in claim 1, wherein the axle has two recesses defined at diametrical opposite sides of the head, and the cap has two protrusions respectively positioned in the recesses.

3. A latching axle assembly comprising:
an axle having a head formed at an end of the axle, and multiple recesses defined at an outer periphery of the head; and
a cap having multiple hooks formed at a lower circumference of the cap and the multiple hooks respectively positioned in the recesses to detachably mount the cap on the head.

4. The latching axle assembly as claimed in claim 3, wherein the axle has two recesses defined at diametrical opposite sides of the head, and the cap has two hooks respectively positioned in the recesses.
